(19) United States
(12) Patent Application Publication
(10) Pub. No.: US 2003/0231615 A1
(43) Pub. Date: Dec. 18, 2003

(54) Virtual Connections for voice over digital subscriber lines

(75) Inventors: Michael Rabinovich, Modiin (IL); Matia Marcu, Natanya (IL); David Rouchbach, Natanya (IL); Eran Raz, Yehud (IL)

Correspondence Address: Fogg Slifer Polglaze Leffert & Jay, P.A., P.O. Box 581009, Minneapolis, MN, 55458-1009, US

(73) Assignee: ADC Telecommunications Israel Ltd.

(21) Appl. No.: 10/171,020

(22) Filed: Jun. 12, 2002

(51) Int. Cl. H04L 12/66

(52) U.S. Cl. 370/352

(57) ABSTRACT

The present invention relates telecommunication systems with virtual connections for voice over digital subscriber lines. In one embodiment, a digital subscriber line (DSL) access device is disclosed. The device comprises a network port, a plurality of local ports and an access function. The network port is adapted to receive cells on at least one aggregated permanent virtual connection. The plurality of local ports are adapted to interface a plurality of local permanent virtual connections. The access function is adapted to translate the cells between aggregated permanent virtual connections and the plurality of local permanent virtual connections.

### TECHNICAL FIELD

The present invention relates generally to the field of data communications or telecommunications and, in particular, virtual connections for voice over digital subscriber lines.

### BACKGROUND

The modern telephone system was primarily designed to transport voice signals between terminals at remote locations. Conventionally, the telephone system makes connections and routes calls through a network using switches and other electronic equipment. Prior to the 1960s, the telephone system used primarily analog switches and other analog equipment. With the increasing capability of computer systems and other digital electronics, the telephone system began to include digital switches and other equipment. For example, Digital Loop Carriers (DLCs) were developed to allow connections from a number of subscribers to be routed to a location remote from the central office and then connected to the central office over a high speed, digital line. Again, however, this digital equipment was primarily designed to handle voice signals.

Over time, telecommunications systems have been used to carry data, other than voice signals, between terminals at remote locations as well. Transporting data has posed a variety of problems for conventional telephone systems. For example, as mentioned, the telephone system was designed to carry low bandwidth voice traffic. Unfortunately, these low bandwidth channels can provide a significant obstacle to providing higher bandwidth data services that have become so popular, e.g., the Internet and other data networks.

To capture a portion of this data market, the telephony industry developed a group of technologies known collectively as “Digital Subscriber Line” (DSL) services or (xDSL) services, e.g., Asymmetrical Digital Subscriber Line (ADSL), High-Bit Rate Digital Subscriber Line (HDSL), Rate Adaptive Digital Subscriber Line (RADSL), Symmetric Digital Subscriber Line (SDSL), etc. These services provide high speed connections over existing copper wires used to carry conventional telephone traffic. These services use various modulation schemes and other techniques to allow the data to be transmitted over the existing copper lines at higher speeds. In addition to data, some of these DSL technologies provide both data and voice services. This voice service is called voice over (VoDSL) service.

The DSL services are typically interfaced with an asynchronous transfer mode (ATM) network. An ATM network transfers voice and data signals back and forth via ATM cells (or packets) which contain a payload (e.g. text field or data field) and a header that contains several fields used by ATM switches to route data. In particular, the header of each ATM cell contains permanent virtual connection (PVC) data that contains routing directions. The ATM cells in the ATM network are interfaced with DSL lines with a DSL access device such as a digital subscriber line access multiplexer (DSLAM) or an integrated multi-access platform (iMAP) device. Existing DSL access devices perform relatively non-intelligent transport functions such as transporting ATM cells between an ATM network and the DSL lines.

In a typical VOATM LES communication system, the ATM cells are routed to and from integrated access devices (LADs). Each LAD provides data and telephony services to end users. The PVC in the ATM cells (ATM PVC's) direct the routing of the ATM cells to a specific LAD. In existing systems, the current VoDSL access method requires creating and maintaining a number of ATM PVC's equal to or greater than the number of IADs. As a result of the relatively large number of ATM PVC's required in existing systems, provisioning the PVC's can become cumbersome. This further leads to higher maintenance costs.

For the reasons stated above, and for other reasons stated below which will become apparent to those skilled in the art upon reading and understanding the present specification, there is a need in the art for an improved communication system that requires less ATM PVC provisioning.

### SUMMARY

The above-mentioned problems and other problems are addressed by embodiments of the present invention and will be understood by reading and studying the following description.

In one embodiment, a digital subscriber line (DSL) access device is disclosed. The device comprises a network port, a plurality of local ports and an access function. The network port is adapted to receive cells on at least one aggregated permanent virtual connection. The plurality of local ports are adapted to interface a plurality of local permanent virtual connections. The access function is adapted to translate the cells between aggregated permanent virtual connections and the plurality of local permanent virtual connections.

In another embodiment, a communication system is disclosed. The communication system includes a local exchange, an access gateway, an asynchronous transfer mode (ATM) network to transmit ATM cells, a plurality of integrated access devices (IADs) and a digital subscriber line (DSL) access device. The access gateway is adapted to translate between time division multiplex (TDM) signals associated with public switched telephone network (PSTN) of the local exchange and the ATM cells of the ATM network. The plurality of IADs adapted to provide data and telephony services to end users. The DSL access device comprises a network port, a plurality of local ports and an access function. The network port is adapted to receive cells on at least one aggregated permanent virtual connection. The plurality of local ports are adapted to interface a plurality of local permanent virtual connections. The access function is adapted to translate the cells between aggregated permanent virtual connections and the plurality of local permanent virtual connections.

In another embodiment, a method of operating a communication system is disclosed. The method comprises aggregating asynchronous transfer mode (ATM) cells into an aggregated permanent virtual connection and transmitting the ATM cells over an ATM network via the aggregated permanent virtual connection.

In yet another embodiment, a method of operating another communication system is disclosed. The method comprises receiving aggregating cells on an aggregated permanent virtual connection across an asynchronous transfer mode (ATM) network. Terminating the aggregated permanent virtual connection and establishing a plurality of local permanent virtual connections from the aggregated permanent virtual connection.

In further another embodiment, another method of operating a communication system is disclosed. The method comprises receiving asynchronous transfer mode (ATM) cells over a plurality of local permanent virtual connections at local ports of a digital subscriber line (DSL) access device. Aggregating the ATM cells on an aggregated permanent virtual connection and transmitting the aggregated ATM cells with the aggregated permanent virtual connection over an ATM network.

### BRIEF DESCRIPTION OF THE DRAWINGS

The present invention can be more easily understood and further advantages and uses thereof more readily apparent, when considered in view of the description of the preferred embodiments and the following figures in which:

FIG. 1 is a block diagram of a communication system of the prior art;

FIG. 2 is a block diagram of one embodiment of a communication system of the present invention;

FIG. 3 is a block diagram of one embodiment of a DSL access device of the present invention;

FIG. 4 is a flow chart illustrating one embodiment of a method of aggregating voice channel for transport in a downstream direction in a DSL system according to the teachings of the present invention; and

FIG. 5 is a flow chart illustrating one embodiment of a method of aggregating voice channel for transport in an upstream direction in a DSL system according to the teachings of the present invention.

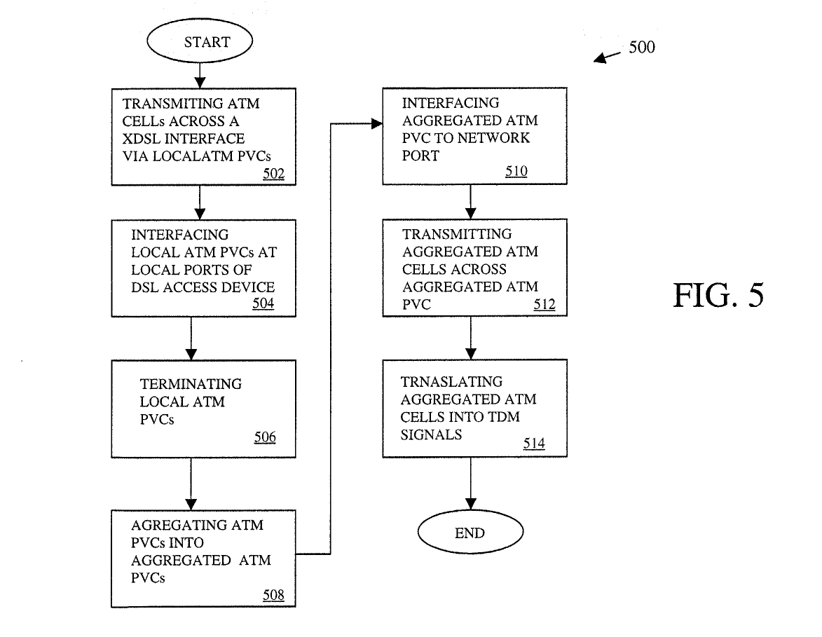

In accordance with common practice, the various described features are not drawn to scale but are drawn to emphasize specific features relevant to the present invention. Reference characters denote like elements throughout Figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

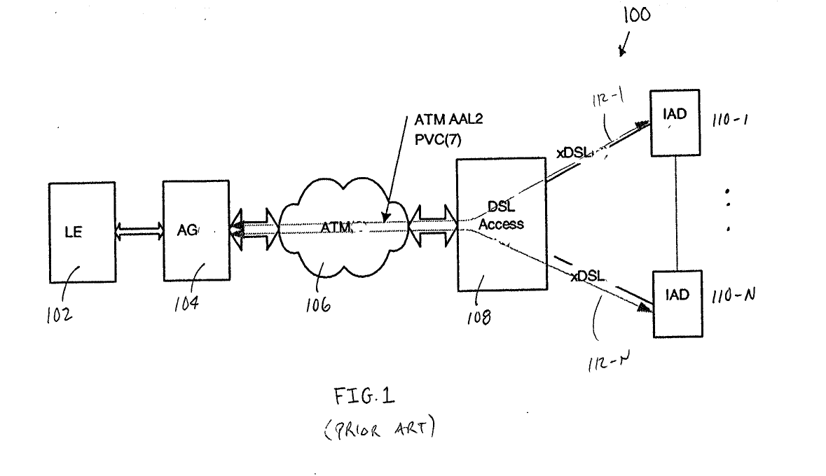

Various embodiments of the present invention provide a communication system that has a reduced number of ATM PVC's for reduced provisioning and maintenance costs. Before further details of the present invention are described in detail, a description of a communication system of the prior art is first discussed to provide further background and to aid in the understanding of the present invention. Referring to FIG. 1, a communication system 100 of the prior art is illustrated. Communication system 100 includes a local exchange (LE) 102, an access gateway (AG) 104, an ATM network 106, a DSL access device 108 and a plurality of IADs 110-1 to 110-N. LE 102 is typically a class 5 switch. The AG 104 provides translation between time division multiplex (TDM) associated with public switched telephone network (PSTN) and ATM cells of the ATM network 106. In the communication system 100 of FIG. 1, the ATM cells have ATM adaptation layer type 2 (AAL2) protocol. The DSL access device 108 provides xDSL access to end users. In particular, the ATM cells are transported between AG 104 and IADs 110-1 to 110-N and over customer drops 112-1 to 112-N. DSL access device 108 communicates ATM cells with IADs 110-1 to 110-N using any one of the xDSL services. Each LAD comprises a network interface as well as a plurality of end user interfaces, e.g., voice and data interfaces.

In the prior art of FIG. 1, the ATM AAL2 PVCs are used to route signals between the AG 104 and the IADs 110-1 to 110-N. Accordingly, the communication system 100 of FIG. 1, requires the establishment and maintenance of a number of ATM PVC's that is equal to or greater than the number of IADs 110-1 to 10-N.

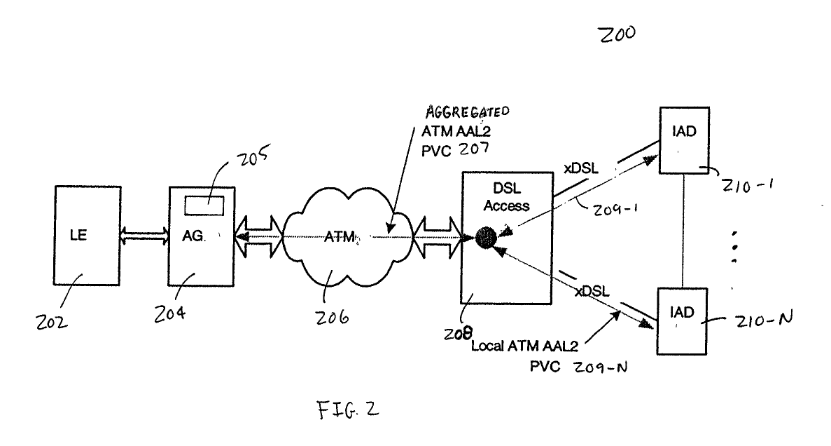

FIG. 2, illustrates one embodiment of a communication system 200 of the present invention. Communication system 200 includes a LE 202, and AG 204, an ATM network 206, a DSL access device 208 and a plurality of IADs 210-1 to 210-N. Unlike communication system 100 of the prior art, communication system 200 aggregates a number of ATM cells over an aggregated permanent virtual connection (aggregated ATM PVC) 207 between the AG 204 and the DSL access device 208. In one embodiment, the AG 204 is adapted to aggregate the ATM cells on the aggregated ATM PVC 207. In this embodiment, the AG 04 includes a gateway function 205 that is adapted to translate TDM signals from the LE 202 into aggregated ATM cells on the aggregated ATM PVC 207.

The DSL access device 208 terminates the aggregated ATM PVC 207 and creates local ATM PVCs 209-1 to 209-N between the DSL access device 208 and IADs 210-1 to 210-N. Further in another embodiment, one or more local ATM PVC's 209-1 to 209-N are associated with each IAD's 210 (1-N). In one embodiment, the DSL access device 208 is a digital subscriber line access multiplexer (DSLAM) and in another embodiment, the DSL access device 208 is an integrated multi-access platform (iMAP) device.

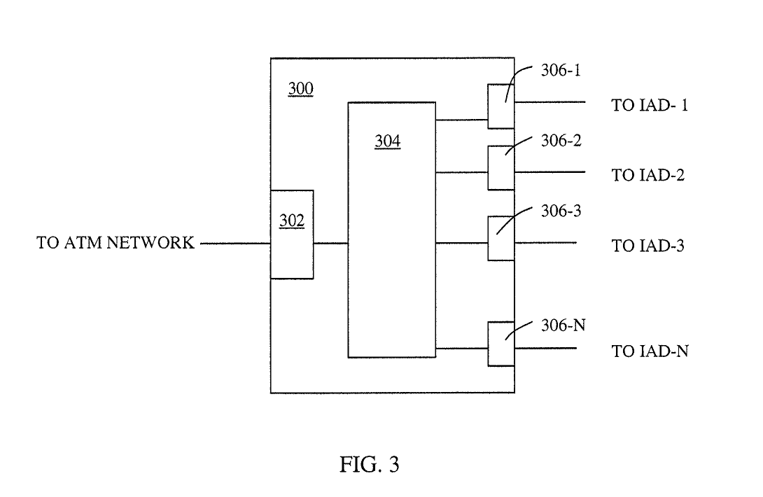

Referring to FIG. 3, a DSL access device 300 of one embodiment of the present invention is illustrated. The DSL access device 300 includes a network port 302 to interface ATM network signals and a plurality of local ports 306-1 to 306-N to interface signals to and from associated IADs (1-N). Also included in the DSL access device 300 is an access function 304. In one embodiment, the access function 304 is adapted to terminate an aggregate ATM PVC received from an ATM network 106 and create local ATM PVCs associated with local ports 306-1 to 306-N from the aggregated ATM PVC in a downstream direction. Moreover, in one embodiment for use in an upstream direction, the access function 304 is adapted to aggregate the local ATM PVCs into an aggregate ATM PVC and transmit the aggregate ATM PVC to an ATM network. In addition, in one embodiment, the access function 304 is implement in software and in another embodiment the access function 304 is implemented in hardware. Beside reducing the number of ATM PVC's and reducing the maintenance costs, the present invention also improves network bandwidth utilization by multiplexing the aggregated ATM PVC bandwidth for a large number of users. In addition, referring back to FIG. 2, the present invention allows for various voice compression methods between the single network aggregated ATM PVC and the local ATM PVCs which allow for higher channel density at the AG 204. In one embodiment, a look-up table is used that defines static relationships between each aggregated identifier (i.e. PVC VPI:VCI:CID) and local identifiers (i.e., local PVC VPI:VCI:CID fields) to keep track of identifiers when local ATM PVCs are aggregated into the aggregated ATM PVC. For example, when the access function 304 receives a cell from an aggregated PVC with VPIa:VCIb:CIDc fields it will replace these fields with VPIx:VCIy:CIDz fields according to this table and visa versa.

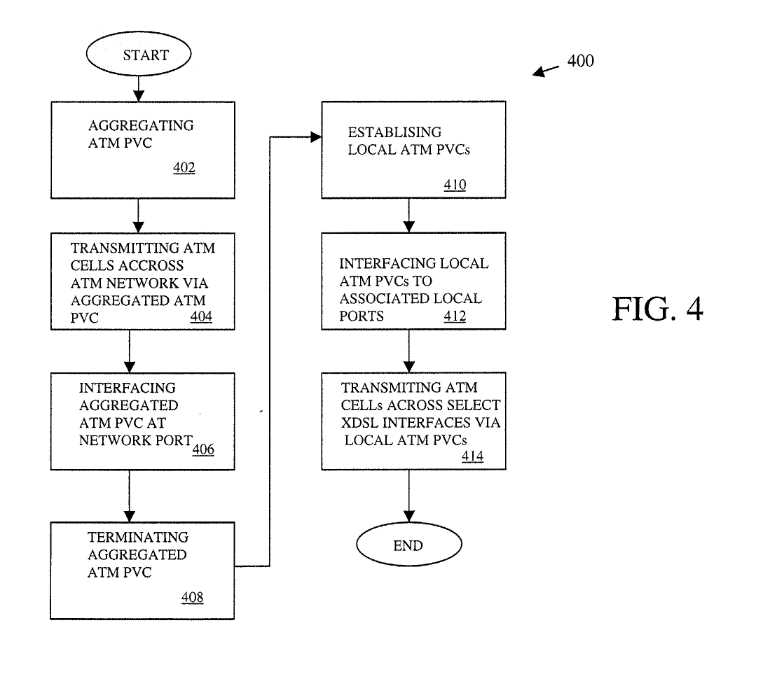

A flow chart 400 illustrating one method of transmitting information across a communication system in a downstream direction of the present invention is shown in FIG. 4. As FIG. 4 illustrates, this method starts by aggregating the ATM PVCs (402). In one embodiment this is done with an access gateway. Aggregated ATM cells are then transmitted across an ATM network via the aggregated ATM PVC (404). The aggregated ATM PVC is interfaced at a network port of a DSL access device (406). The aggregated ATM PVC is then terminated (408) and local ATM PVCs are established (410). Each local ATM PVCs and associated ATM cells are then interfaced with an associated local port in the DSL access device (412). The ATM cells are then transmitted across select xDSL interfaces via associated local ATM PVC to associated IADs (414).

Flow chart 500 illustrates one method of transmitting information across a communication system in an upstream direction. As illustrated, ATM cells having local ATM PVCs are transmitted across a plurality of the xDSL interfaces from a plurality of IADs (502). The each local ATM PVCs is interfaced at an associated local port of a DSL access device (504). The local ATM PVCs are then terminated (506) and aggregated into an aggregated ATM PVC (508). The aggregated ATM PVC is then interfaced with a network port of the DSL device (510). The ATM cells in the aggregated ATM PVC are then transmitted across an ATM network (512). The ATM cells in the aggregated ATM PVC are then translated into TDM signals at an access gateway (514).

Although specific embodiments have been illustrated and described herein, it will be appreciated by those of ordinary skill in the art that any arrangement, which is calculated to achieve the same purpose, may be substituted for the specific embodiments shown. This application is intended to cover any adaptations or variations of the present invention. Therefore, it is intended that this invention be limited only by the claims and the equivalents thereof.

What is claimed is:

1. A digital subscriber line (DSL) access device, the device comprising:
a network port adapted to receive cells on at least one aggregated permanent virtual connection;
a plurality of local ports adapted to interface a plurality of local permanent virtual connections; and
an access function adapted to translate the cells between aggregated permanent virtual connections and the plurality of local permanent virtual connections.

2. The device of claim 1, wherein the network port interfaces the at least one aggregated permanent virtual connection to and from an asynchronous transfer mode network.

3. The device of claim 1, further including:
a look-up table of defined relationships between aggregated and local identifiers, wherein the access function uses the look-up table when translating cells between the aggregated permanent virtual connections and the plurality of local permanent virtual connections.

4. The device of claim 1, wherein the plurality of local ports interface the plurality of local permanent virtual connections to and from associated integrated access devices.

5. The device of claim 4, wherein one or more local permanent virtual connections are associated to each integrated access device.

6. A communication system comprising:
a local exchange;
an asynchronous transfer mode (ATM) network to transmit ATM cells;
an access gateway adapted to translate between time division multiplex (TDM) signals associated with public switched telephone network (PSTN) of the local exchange and the ATM cells of the ATM network;
a plurality of integrated access devices (IADs) adapted to provide data and telephony services to end users; and
an digital subscriber line (DSL) access device, the DSL access device comprising,
a network port adapted to receive ATM cells on at least one aggregated permanent virtual connection, the network port is coupled to the ATM network,
a plurality of local ports adapted to interface a plurality of local permanent virtual connections, each local port is coupled to an associated IAD; and
an access function adapted to translate the cells between aggregated permanent virtual connections and the plurality of local permanent virtual connections.

7. The communication system of claim 6, wherein each local port of the DSL access device is coupled to its associated IAD via an xDSL connection.

8. The communication system of claim 6, wherein the DSL access device is one of a digital subscriber line access multiplexer (DSLAM) and an integrated multi-access platform (iMAP) device.

9. The communication system of claim 6, wherein the aggregated permanent virtual connections and the local permanent virtual connections have ATM adaptation layer type protocol.

10. The communication system of claim 6, wherein the access gateway further comprises:
a gateway function adapted to translate between the TDM signals and the aggregate permanent virtual connections.

11. The communication system of claim 10, further including:
a look-up table of defined relationships between aggregated and local identifiers, wherein the access function uses the look-up table when translating cells between the aggregated permanent virtual connections and the plurality of local permanent virtual connections.

12. A method of operating a communication system, the method comprising:
aggregating asynchronous transfer mode (ATM) cells into an aggregated permanent virtual connection; and
transmitting the ATM cells over an ATM network via the aggregated permanent virtual connection.

13. The method of claim 12, further comprising:
receiving the aggregated ATM cells in the aggregated permanent virtual connection at a network port of an DSL access device;
terminating the aggregated permanent virtual connection;
establishing a plurality of local permanent virtual connections, wherein each local permanent virtual connection is associated with one or more of the ATM cells; and
transmitting each ATM cell over associated local virtual connections to an associated integrated access devices.

14. A method of operating a communication system, the method comprising:
receiving aggregating cells on an aggregated permanent virtual connection across an asynchronous transfer mode (ATM) network;
terminating the aggregated permanent virtual connection; and
establishing a plurality of local permanent virtual connections from the aggregated permanent virtual connection.

15. The method of claim 14, further comprising:
translating time division multiplex (TDM) signals to the aggregated ATM cells on the aggregated permanent virtual connection at an access gateway; and
transmitting the aggregated cells on the aggregated permanent virtual connection across the ATM network.

16. The method of claim 14, further comprising:
coupling the cells between a local port of a digital subscriber line access device and an associated integrated access device over one of the local permanent virtual connections.

17. The method of claim 14, further comprising:
interfacing the aggregated permanent virtual connection at a network port of a digital subscriber line (DSL) access device; and
interfacing the plurality of local permanent virtual connections at a plurality of local ports of the DSL access device.

18. The method of claim 14, wherein the DSL access device is one of a digital subscriber line access multiplexer (DSLAM) and an integrated multi-access platform (iMAP) device.

19. A method of operating a communication system, the method comprising:
receiving asynchronous transfer mode (ATM) cells over a plurality of local permanent virtual connections at local ports of a digital subscriber line (DSL) access device;
aggregating the ATM cells on an aggregated permanent virtual connection; and
transmitting the aggregated ATM cells with the aggregated permanent virtual connection over an ATM network.

20. The method of claim 19, further comprising:
transmitting the ATM cells between a plurality of integrated access devices and the plurality of local ports of the DSL access device.

21. The method of claim 19, further comprising:
receiving the aggregated ATM cells on the aggregated permanent virtual connection at an access gateway;
translating the aggregated ATM cells to time division multiplex (TDM) signals associated with public switched telephone network; and
transmitting the TDM signals to a local exchange.

22. The method of claim 19, wherein the DSL access device is one of a digital subscriber line access multiplexer (DSLAM) and an integrated multi-access platform (iMAP) device.
